(19) United States
(12) Patent Application Publication
(10) Pub. No.: US 2004/0006467 A1
(43) Pub. Date: Jan. 8, 2004

(54) Method of automatic language identification for multi-lingual text recognition

(76) Inventors: Konstantin Anisimovich, Moscow (RU); Vadim Tereshchenko, Moscow (RU); Vladimir Rybkin, Moscow (RU)

Correspondence Address: Sergey Platonov, ABBYY Software House, 8, Butirskaya, P. O. Box #72, Moscow, 127015, RU

(21) Appl. No.: 10/305,499

(22) Filed: Nov. 29, 2002

(30) Foreign Application Priority Data
Jul. 7, 2002 (RU) 2002127826 A

(51) Int. Cl. G10L 15/04

(52) U.S. Cl. 704/251

(57) ABSTRACT

The disclosed invention utilizes a complex estimation-based approach to identify languages of portions of a multi-lingual text, recognized from a bit-mapped image. The method comprises besides the traditional steps like the document segmentation, new ones such as generating and testing of a hypothesis about the characters in the word tokens.

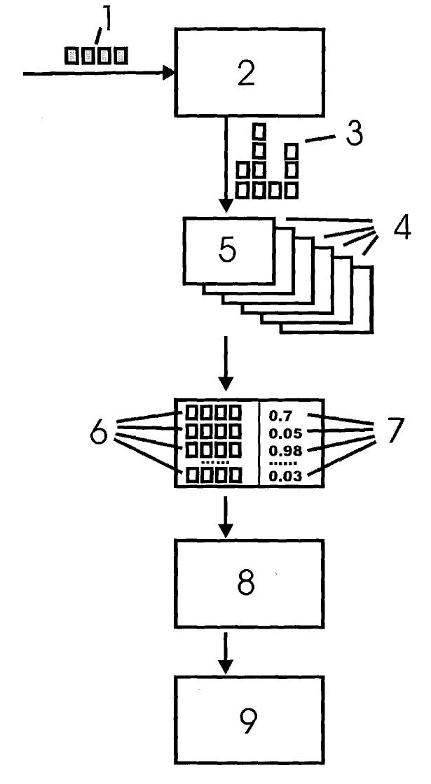

The method further includes definition of selected language models set, word estimation via language models, dictionaries set definition for language selection, estimation of word correspondence with chosen languages, calculating a complex estimation for the word taking into account the most or all of above mentioned estimations.

The complex estimation may also include factor of characters and/or words mutual correspondence within the line and/or the text, mutual geometric correspondence of characters within the word and/or the line, linguistic correspondence of the word with neighbors, estimation of image of word token reconstruction accuracy in the presence of distortion.

References Cited
U.S. Pat. Documents

| | | | |
|---|---|---|---|
| 3988715 | October, 1976 | Mullan et al. | 382/228. |
| 4829580 | May, 1989 | Church | 704/9. |
| 5062143 | October, 1991 | Schmitt | 704/9. |
| 5182708 | January, 1993 | Ejiri | 704/9. |
| 5371807 | December, 1994 | Register et al. | 704/9. |
| 5418951 | May, 1995 | Damashek | 704/9. |
| 5548507 | August, 1996 | Martino et al. | 704/9. |
| 6047251 | Apr. 4, 2000 | Pon et al. | 382/229 |
| 6,370,269 | Apr. 9, 2002 | Al-Karmi et al. | 382/197 |

### FIELD OF THE INVENTION

The present invention is generally directed to the discrimination between various languages in communications, and more specifically to the automatic recognition of different languages in a document containing portions of text written in different languages for optical character recognition purposes and the like.

### BACKGROUND OF THE INVENTION

Usually, character recognition, and particularly optical character recognition, involves the parsing a bit-mapped image of a document into individual symbols and groups of symbols, and comparing the images of symbols to model representative information of various characters related to the letters of an alphabet, numbers, and the like. To increase the accuracy of the recognition process, OCR engines employ techniques that are based upon the characteristics of a particular language. For instance, information about a particular language can be used to select appropriate classifiers, dictionaries, as well as to recognize language-specific models, formats for dates, numbers, etc.

In the past, if an OCR system was capable of recognizing text in different languages, the user was required to manually specify the language of the text in a scanned image to enable the OCR system to accurately recognize the symbols and words in the document image. For a single-language document, this task was relatively simple. However, for optimal OCR processing of multi-lingual pages, different zones containing text in different respective languages needed to be demarcated, and each zone identified with the correct language label. The need for such manual intervention can be labor intensive, which results in greater expense and significantly slows down the overall image-to-text conversion process.

Multi-lingual documents are becoming more and more common. Examples of such documents include user manuals that are targeted for multiple countries, and hence might have multiple languages on one page, and travel brochures which provide concise amounts of information in a variety of multi-lingual layouts. In these types of documents, the same type of information might be described in different languages in different paragraphs, columns or pages. Thus, there is an enormous need for the ability to automatically discriminate between, and identify, different languages in a single document.

In the past, efforts at automatic language identification have employed one of two general approaches. In one approach, the language identification relies on features that are extracted from images of word tokens. The characters classifier is usually generic to all languages presumed to be present in the document. Examples of this approach are described, for example, in U.S. Pat. No. 6,047,251, Apr. 4, 2000 and in U.S. Pat. No. 6,370,269 Apr. 9, 2002.

Techniques of the type described in these references require a significant amount of text in the subject language to make the identification reliable. If the text language changes on a relatively frequent basis, e.g., from line to line, it is not possible to obtain sufficient statistical feature-based evidence to distinguish one language from the other.

Another approach to language identification utilizes word frequency and bigram probabilities. This approach is only applicable to documents of the type in which each page contains text in a single language. It does not provide the capability to distinguish between two different languages on the same page, absent prior manual segmentation. Furthermore, it requires document images having relatively high fidelity, in order to provide reliable transition probabilities for the language models.

It is desirable, therefore, to have a system for automatically distinguishing between and identifying multiple languages which does not require prior manual input and can reliably identify a plurality of different languages on a single page, and thereby enable optical character recognition to be effected with greater speed and accuracy.

### SUMMARY OF THE INVENTION

The present invention discloses a method of language identification of recognized text from bit-mapped image from any source. In short the method on the stage of hypothesis forming of word correspondence to certain language comprises the following steps:

defining the set of selected linguistic models,

forming and examining a hypothesis about correspondence of character group to certain language, including linguistic models word estimation.

The advantages provided by the invention can be achieved, if on the step of forming a hypothesis about correspondence of the characters group presumed to comprise a word to a certain language the following steps are to be performed

calculating of a complex estimation of the characters group presumed to comprise a word,

dictionaries set definition for final language choice.

The said complex estimation in its turn can comprise at least the following factors

word estimation via language models along with recognition quality factor,

estimation of reconstruction accuracy of parts of images of word token, including distorted images,

a set of special factors, defining the characters' relative placement and/or words mutual correspondence within the text, including at least

geometric correspondence between characters within the word and/or the line,

linguistic correspondence of words with neighbors.

The word token recognition is performed by means of a classifier that is generic to each of said plural languages.

Further features of the invention, and the advantages provided thereby, are described in detail hereinafter and illustrated in the accompanying drawing.

### BRIEF DESCRIPTION OF THE DRAWING

The FIGURE is an overall flow diagram of the present invention.

### DETAILED DESCRIPTION OF THE INVENTION

To facilitate an understanding of the present invention, it is described hereinafter with particular reference to the optical character recognition of a document page containing text in multiple languages. While the present invention is particularly suited for such an application, it will be appreciated that it is not limited to this particular type of use. Rather, the principles which underlie the invention can be employed in a variety of different contexts, wherever the need to distinguish between, and identify, different languages is desirable.

The automatic identification of languages, and more generally, bit-mapped image character recognition, can be carried out on a variety of computer systems. While the particular hardware components of a computer system do not form part of the invention itself, they are briefly described herein to provide a thorough understanding of the manner in which the features of the invention cooperate with the components of a computer system, to produce the desired results.

Generally speaking, optical character recognition employs a classifier that recognizes patterns, or symbols, that correspond to the characters of an alphabet, numbers, punctuation marks, etc. When the specific language of a document being processed is known, the classifier can be tailored to that language. However, multiple languages present in a document may not be known a priori. In this case, the character classifier that is employed for the generation of the initial word hypotheses is preferably one that is generic to all of the candidate languages that are to be recognized. For example, if the optical character recognition technique is designed to identify, and discriminate between, the various Romance languages, the generic symbol classifier can be set up to recognize all or most of the symbols in those languages. As an alternative to the use of a generic classifier, it is possible to employ a classifier that is specific to one language, but which is augmented with post-processing capabilities to recognize symbols, which may not appear in that language.

Referring to FIGURE, the recognized images of word token (1) from any source bit-mapped image are sent to a classifier (2) that is generic to each of said plural languages.

A result of the classifier's work is a plurality of variants of characters (3) accompanied with the corresponding reliability factor.

All this plurality of groups of characters presumed to comprise possible words is sent to a linguistic and non-linguistic models set (5). Said linguistic models (5) are selected either manually or automatically to form a set of languages expected to be present in the recognized text.

After examination of plurality of characters by word model a plurality of possible words (6) along with corresponding closeness factors to each model (7) accompanied by additional data in the form of complex estimation of each word is directed to an analysis and selection procedure (8).

The results of the whole analysis, together with all the above mentioned factors, are sent to the final procedure (9) of making a decision about word correspondence to a certain language.

The scope of the invention is indicated by the appended claims, rather than the foregoing description, and all changes that come within the meaning and range of equivalence thereof are intended to be embraced therein.

What is claimed is:

1. A method for automatically determining one or more languages associated with text in a bit-mapped image, comprising the steps of:
segmenting the image into a plurality of images of word token,
recognition of separate characters in said images of word token,
joining separate characters into groups presumably comprising words,
forming at least one hypothesis about correspondence of the characters group, presumably comprising a word, to a certain language,
accepting the hypothesis about correspondence of the characters group, presumably comprising a word, to a certain language;
the said step of forming a hypothesis about correspondence of the characters group, presumably comprising a word, to a certain language, further comprises at least the following steps
definition of selected language models set,
estimation of word correspondence with lingual and non-lingual models.

2. The method of claim 1, wherein the step of recognition of separate characters in said images of word token is performed by a classifier, that is generic to each of said plural languages.

3. The method of claim 1, wherein the step of accepting the hypothesis about correspondence of the characters group, presumably comprising a word, to a certain language further comprises
defining a set of dictionaries for the estimation of the word correspondence to a certain language,
estimation of the word correspondence with defined dictionaries.

4. The method of claim 3, wherein the defining of a set of dictionaries for the estimation of language correspondence of the text is made manually.

5. The method of claim 3, wherein the defining of a set of dictionaries for the estimation of language correspondence of the text is made automatically.

6. The method of claim 1, wherein the step of accepting the hypothesis about correspondence of the characters group, presumably comprising a word, to a certain language further comprises a calculation of complex estimation, said complex estimation including at least
character recognition quality estimation,
dictionary conformity estimation, including language models conformity estimation.

7. The method of claim 6, wherein complex estimation further comprises calculation of a special factor of characters mutual correspondence.

8. The method of claim 6, wherein complex estimation further comprises calculation of a special factor of words relative placement.

9. The method of claim 7, wherein complex estimation further comprises a special factor of words correspondence calculation.

10. The method of claim 9, wherein the special factor comprises geometric conformity of characters within the word.

11. The method of claim 9, wherein the special factor comprises geometric conformity of characters within the line.

12. The method of claim 9, wherein the special factor comprises a linguistic correspondence of word with neighbors,

13. The method of claim 9, wherein the special factor includes accuracy estimation of a word reconstruction from token image, and also in the presence of distortion.
